(19) United States
(12) Patent Application Publication
(10) Pub. No.: US 2014/0081969 A1
(43) Pub. Date: Mar. 20, 2014

(54) Methods, Systems, and Program Products for Locating Tagged Resources in a Resource Scope

(71) Applicant: DEEP RIVER VENTURES. LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/622,371

(22) Filed: Sep. 19, 2012

(51) Int. Cl. G06F 17/30

(52) U.S. Cl. 707/736; 707/E17.005

(57) ABSTRACT

Methods and systems are described for locating tagged resources in a resource scope. In an aspect, a first tag is detected that tags at least one resource. A first scope descriptor for the first tag is identified. A second scope descriptor for the first tag is identified. A first set of resources is determined that are in a first resource scope specified by the first scope descriptor and that are tagged with the first tag. A second set of resources is determined that are in a second resource scope specified by the second scope descriptor and that are tagged with the first tag, wherein a third resource tagged with the first tag is included in one of the first set and the second set.

### RELATED APPLICATIONS

This application is related to the following commonly owned U.S. patent applications: application Ser. No. 13/622,366 (Docket No DRV0002) filed on 2012/09/19, entitled “Methods, Systems, and Program Products for Tagging a Resource”;

application Ser. No. 13/622,367 (Docket No DRV0005) filed on 2012/09/19, entitled “Methods, Systems, and Program Products for Distinguishing Tags for a Resource”;

application Ser. No. 13/622,372 (Docket No DRV0007) filed on 2012/09/19, entitled “Methods, Systems, and Program Products for Navigating Tagging Contexts”;

application Ser. No. 13/622,370 (Docket No DRV0008) filed on 2012/09/19, entitled “Methods, Systems, and Program Products for Automatically Managing Tagging of a Resource”; and

application Ser. No. 13/622,368 (Docket No DRV0021) filed on 2012/09/19, entitled “Methods, Systems, and Program Products for Identifying a Matched Tag Set”.

### BACKGROUND

Tagging has become a common way to allow users to categorize and/or otherwise create relationships between and among resources on the Web. Resources, such as images, video, audio, documents, and other web content are tagged every day. One of the disadvantages of tagging is that it tags often relates more resources than users can manage. Attempts to address this problem have included isolating tags and resources to specific groups for specific purposes and giving tags definitions. These attempts to create the opposite problem by restricting the universe of resources and/or tags. Users of tags need a way to deal with tagged resources in sets with sizes that are useful and manageable but the universe of tagged resources need not be restrained unnecessarily.

Accordingly, there exists a need for methods, systems, and computer program products for locating tagged resources in a resource scope.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for locating tagged resources in a resource scope. In one aspect, the method includes detecting a first tag that tags at least one resource. The method further includes identifying a first scope descriptor for the first tag. The method still further includes identifying a second scope descriptor for the first tag. The method additionally includes determining a first set of resources that are in a first resource scope specified by the first scope descriptor and that are tagged with the first tag. The method also includes determining a second set of resources that are in a second resource scope specified by the second scope descriptor and that are tagged with the first tag, wherein a third resource tagged with the first tag is included in one of the first set and the second set. Performing at least one the preceding actions comprising the method includes execution of an instruction by a processor.

Also, a system for locating tagged resources in a resource scope is described that includes one or more processors and logic encoded in one or more tangible media for execution by the one or more processors that when executed is operable for detecting a first tag that tags at least one resource; identifying a first scope descriptor for the first tag; identifying a second scope descriptor for the first tag; and determining a first set of resources that are in a first resource scope specified by the first scope descriptor and that are tagged with the first tag; and determining a second set of resources that are in a second resource scope specified by the second scope descriptor and that are tagged with the first tag, wherein a third resource tagged with the first tag is included in one of the first set and the second set.

Further, a system for locating tagged resources in a resource scope is described. The system includes a tagging component for detecting a first tag that tags at least one resource. The system further includes a scope director component for identifying a first scope descriptor for the first tag. The system still further includes the scope director component for identifying a second scope descriptor for the first tag. The system yet further includes a scope match component for determining a first set of resources that are in a first resource scope specified by the first scope descriptor and that are tagged with the first tag. The system additionally includes the scope match component for determining a second set of resources that are in a second resource scope specified by the second scope descriptor and that are tagged with the first tag, wherein a third resource tagged with the first tag is included in one of the first set and the second set. The system also includes a processor, wherein at least one of the tagging component, the scope director component, and the scope match component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for locating tagged resources in a resource scope according to an aspect of the subject matter described herein;

FIG. 3 is a block diagram illustrating an arrangement of components for locating tagged resources in a resource scope according to another aspect of the subject matter described herein;

FIG. 4A is a block diagram illustrating an arrangement of components for locating tagged resources in a resource scope according to another aspect of the subject matter described herein;

FIG. 4B is a block diagram illustrating an arrangement of components for locating tagged resources in a resource scope according to another aspect of the subject matter described herein;

FIG. 4C is a block diagram illustrating an arrangement of components for locating tagged resources in a resource scope according to another aspect of the subject matter described herein;

FIG. 4D is a block diagram illustrating an arrangement of components for locating tagged resources in a resource scope according to another aspect of the subject matter described herein;

FIG. 5 is a network diagram illustrating a system for locating tagged resources in a resource scope according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein;

FIG. 6C is a diagram illustrating a user interface presented via a display according to another aspect of the subject matter described herein;

FIG. 6D is a diagram illustrating a user interface presented via a display according to another aspect of the subject matter described herein; and

FIG. 6E is a diagram illustrating a user interface presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present specification, including definitions, will control. In addition, the materials, methods, and examples are illustrative only and not intended to be limiting.

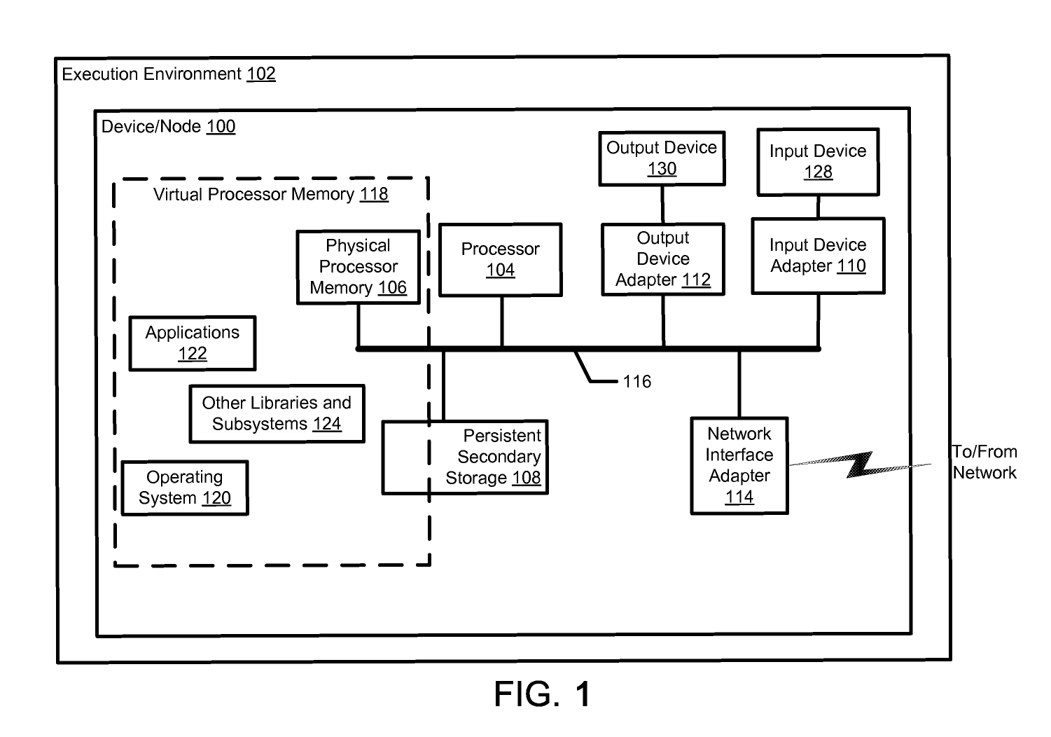

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. The execution environment is said to be the execution environment of the device and/or devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

A “user interface (UI) element handler” component, as the term is used herein, includes a component of configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a user agent from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, the term “network protocol” refers to a formal set of rules, conventions and data structures that governs how computers and other network devices exchange information over a network. The rules, conventions, and data structures are said to be specified or defined in a specification and/or schema.

An “interaction”, as the term is used herein, refers to any activity including a user and an object where the object is a source of sensory data detected by the user. In an interaction the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction. The term “operational component” of a device, as used herein, refers to a component included in performing an operation by the device.

Interaction information for one object may include and/or otherwise identify interaction information for another object. For example, a motion detector may detect user's head turn in the direction of a display of a portable electronic device. Interaction information identifying the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by a processor to present an attention output. The aspects described serve merely as examples based on the definition of attention information, and do not provide an exhaustive list of suitable forms and content of attention information.

As used herein the term “attention criterion” refers to a criterion that when met is defined as indicating that interaction between a user and an object is or maybe inadequate at a particular time and/or during a particular time period. In other words, the user is not directing adequate attention to the object.

As used herein, the term “tag” refers to a character string, which may include one or more words, which may be associated with a resource to create an association between the resource and another resource also tagged with the tag. Tags are often used in sharing media, social bookmarking, social news and blog entries to help users search for associated content. In some contexts, the term “tagging” as used herein refers to the process of associating a tag with a resource that can be tagged. As used herein, the term “tagged association” refers to an association that identifies a tag and a resource that is tagged with the tag. A resource is said to be “tagged” with a tag when a tagging process, also referred to as “tagging”, has successfully created a tagged association. In other contexts, a “tagging” refers to a tagged association.

The term “matched tag”, as used herein, refers to an association that identifies a tag and a tagging criterion, where the tagging criterion is based on data other than the tag. The tagging criterion may be based additionally on the tag. The term “tagging association”, as used herein, refers to a matched tag represented in a memory, either persistent and/or volatile. For example, a tagging association may be realized as a record that includes and/or identifies a tag and a tagging criterion. The terms “matched tag” and “tagging association” are used interchangeably. When the term “matched tag” refers to something other than its tagging association, it will be made clear. For example, a reference to matched tag presented in a user interface clearly identifies a UI element that identifies and/or otherwise represents and/or otherwise identifies a matched tag either realized or to be realized in a tagging association. A tagged association, defined above, may identify a matched tag and a resource that is tagged with the tag identified by the matched tag. Such an association is also referred to herein as a “matched tag association”. A resource may be tagged with a matched tag when a tagging criterion identified by the matched tag is met for the resource.

As user herein, the term “vocabulary” refers to a set of valid values that can be assigned to and/or included in a data element. With respect to a tag, a vocabulary defines valid tags. A vocabulary may be specified by one or more rules and/or by identifying one or more valid values directly and/or indirectly.

As used herein, the term “dictionary” refers a vocabulary wherein one or more terms in the vocabulary is assigned a definition. A “definition” as the term is used herein refers to information that identifies semantic information about a data value, such as at tag. Semantic information may include one or more of a textual description of a meaning of the term, an audio description, a visual description, and information identifying a use or context for the term. A use and/or context may be identified, for example, by identifying a part of speech, a dialect or language, an antonym, a synonym, and/or an example usage of the defined data value.

As used herein, any reference to an entity “in” an association is equivalent to describing the object as “identified” by the association, unless explicitly indicated otherwise.

As used herein, the term “communication” refers to information including a message sent and/or for sending via a network between communicants. A message may include text data, audio data, and/or image data. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A communications protocol defines and/or otherwise identifies an address space including communications addresses for delivering data sent in a communication from one communications agent to another. A communications protocol is a type of network protocol.

The term “communicant alias” as used herein refers to an identifier of a communicant in a communication where the communicant alias is not a communications address included in an address space of a communications protocol for sending and/or receiving data in the communication.

The term “attachment” as used herein refers to a portion of a communication that includes data from one communicant to another other than data in the message portion. A resource sent as an attachment is data that is typically not presented “inline” or in a message included in a message portion of a communication. Email attachments are perhaps the most widely known attachments included in communications. An email attachment is a file or other resource sent along with an email in a portion of the email separate from a message portion. A communication may include one or more resources as one or more attachments.

The terms “contactor” and “contactee” identify roles in a communication. A “contactor” provides information for identifying a “contactee” in a communication. A contactee may be included in a communication by a contactor and/or the contactor's communications agent. A contactor and/or a contactee are roles of a user or communicant of a communications agent and may be a living being, a node, a component, and/or an application. Both a contactor and a contactee are communicants in a communication.

As used here, the term “tagging-attribute association” refers to an association that identifies one or more tagging criterion and a resource attribute that the one or more tagging criterion are each based on. That is, whether a tagging criterion identified in a tagging-attribute association is met for a specified resource depends on an attribute of the resource identified by the tagging-attribute association. The term attribute, as used herein, includes the resource, as a resource is considered to be an attribute of itself and/or otherwise to include at least some of its attributes.

As used herein, the term “resource scope” refers a bounded space in which a resource may be identified. The space may be any space in which a resource may be locate and/or otherwise identified. A bounded may be may include one or more of an identifier space such as file system identifier space and/or a URI address space, a storage space, a geospatial space, a demographic space, and a data type—to name a few examples. space, defines a set of resources from which resources may be identified. For example, the files within a specified folder and its subfolders in a file system define and/or otherwise specify a resource scope. All user accounts that have an administrator security role define another resource scope. The present disclosure describes a resource scope with respect to resources tagged with a specified tag that makeup a set, referred to herein as a “tagged resource set”. A tagged resource set may include a resource tagged with a tag identified by a matched tag.

In specifying a resource scope, one or more criterion may be specified. The terms “criterion” and “constraint” are used interchangeably herein, with respect to a resource scope. A criterion included in specifying a resource scope is referred to herein as a “scope criterion”. A scope criterion may be expressed via any suitable manner, such as a file name, a wildcard expression, a regular expression, a data store location, a data base query, geospatial coordinates, a time, a date, a duration, a relationship to a user, and/or an address—too name a few examples. With respect to a tag, a scope criterion included in defining a resource scope differs from a tagging criterion for the tag in that the scope criterion included in defining a resource scope need not be met in order for a resource to be tagged with the tag. Further a resource scope may be used for purposes other than processing related to a tagged resource.

One or more scope criterion that together specify and/or otherwise define a resource scope is/are referred to herein as a “scope descriptor”. When all the criteria in a scope descriptor are met for a resource, the resource is in the resource scope defined by the scope descriptor. The one or more separate criterion in a scope descriptor may be evaluated in any order suitable or desirable in any given embodiment. In an aspect described below, one scope criterion, that may be included in a scope descriptor, may be specified to determine and/or otherwise identify when the scope descriptor is “active”. A scope criterion that indicates whether a scope descriptor is active is referred to herein as a “scope condition”. In a further aspect a scope descriptor may include no other criterion indicating the resource scope includes all resources accessible to an application, subsystem, execution environment, and/or group of any of the preceding that are processing and/or otherwise making use of the scope descriptor. Those skilled in the art will understand that whether a scope criterion in a scope descriptor is called a scope condition or not depends on the role played by the scope criterion. The subject matter may be described without referring to a scope criterion in the role of a scope condition without limiting the scope of subject matter.

Although, those skilled in the art will know that a scope criterion may be defined as “met” when it is true or may be defined as “met” when it is not true; for purposes of the present disclosure, A scope criterion is said to be “met” for a resource when it indicates the resource is in the resource scope defined by the scope descriptor, and is to be “not met” otherwise. A scope criterion in the role of a scope condition in a scope descriptor is said to be “met” when it indicates the scope descriptor is active, as is said to be “not met” otherwise. In an aspect, a scope descriptor may not include a scope condition or may include a scope condition that is always met. Such a scope descriptor is active by definition. Whether a criterion, in a scope descriptor is met or is not met, may depend on an evaluation of the scope criterion that is based on an identifiable entity. For a scope condition, such an entity is referred to herein as a “condition entity”. More generally, for a scope criterion, such an entity is referred to herein as a “scoping entity”. Exemplary entities include a user, a document, a measure of time, a location, and the like.

An association between a tag and scope descriptor is referred to herein as a “scoped tag”. A scoped tag is also referred to herein as a match set. As defined above, a tagging criterion may be used to determine whether to tag a particular resource with a particular tag. The tagging criterion is associated with the tag by a matched tag. A scope descriptor identifies resource scope that includes a set of resources. Scope descriptors are necessarily associated with resources.

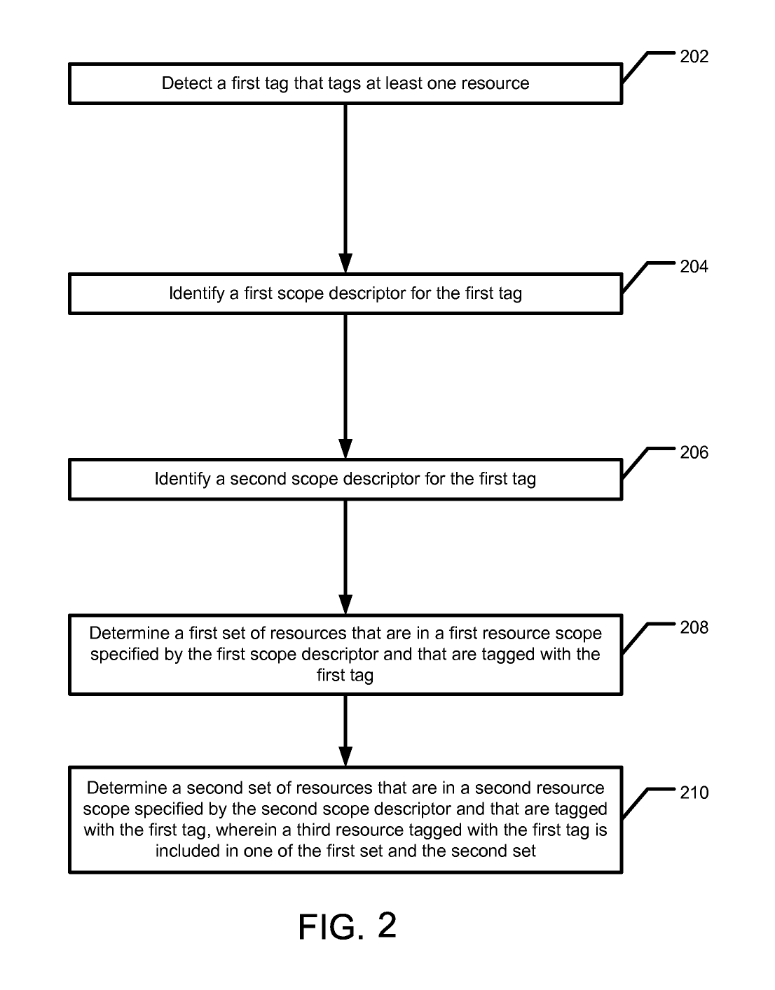

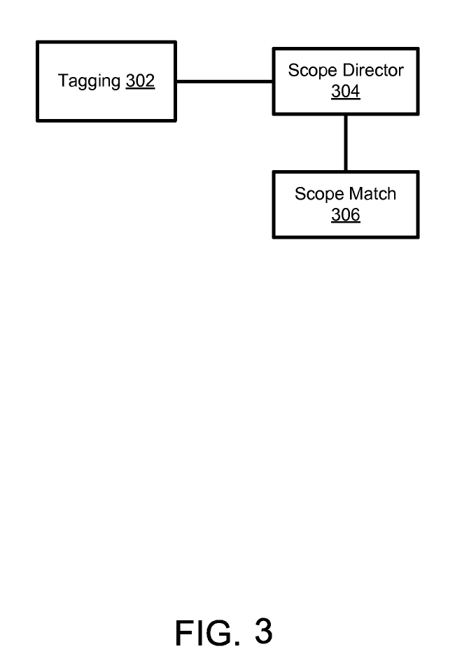

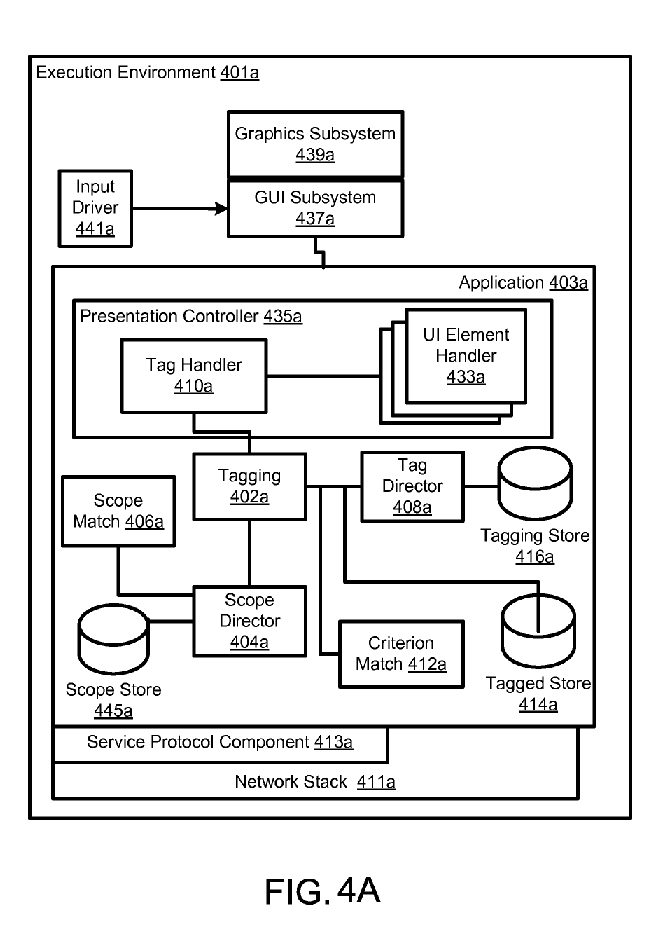

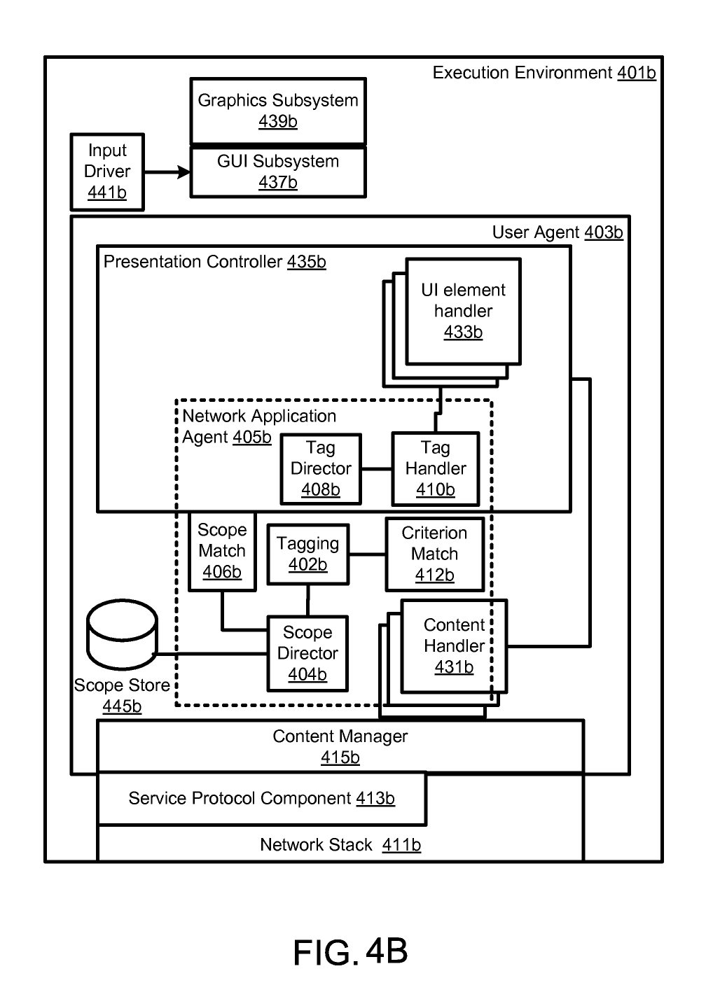

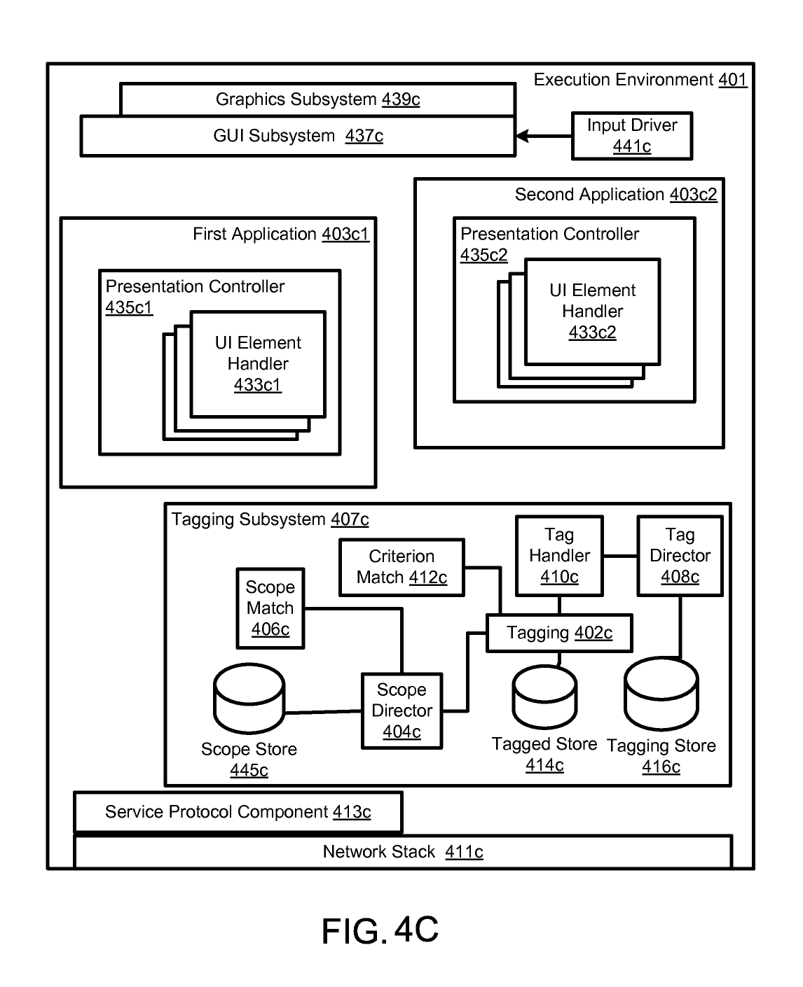

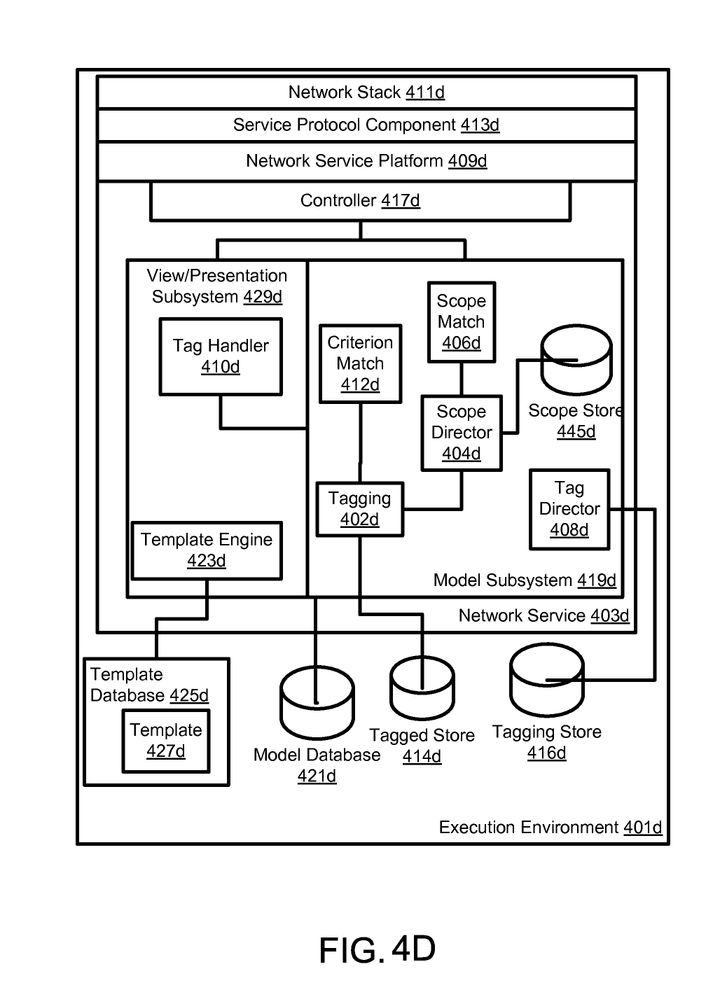

FIG. 3 illustrates a system that operates in an execution environment, such as execution environment 102 in FIG. 1, to perform the method illustrated in FIG. 2. The system illustrated includes a tagging component 302, a scope director component 304, and a scope match component 306. A suitable execution environment includes a processor, such as processor 104, to process an instruction in at least one of a tagging component, a scope director component, and a scope match component. Some or all of the exemplary components illustrated in FIG. 3 may be adapted to operate in a number of execution environments to perform the method illustrated in FIG. 2. FIGS. 4A-D are each block diagrams illustrating the components of FIG. 3 and/or analogs of the components of FIG. 3 respectively adapted to operate in an execution environment 401a, an execution environment 401b, an execution environment 401c, and/or an execution environment 401d that each include and/or otherwise are provided by one or more nodes. Components, illustrated in FIGS. 4A-D, are identified by numbers with an alphanumeric suffix. A component may be referred to generically in the singular or the plural by dropping a suffix or a portion thereof of the component's identifier. Execution environments; such as execution environment 401a, execution environment 401b, execution environment 401c, execution environment 401d, and their adaptations and analogs; are referred to herein generically as an execution environment 401 or execution environments 401 when describing more than one. Other components identified with an alphanumeric suffix may be referred to generically or as a group in a similar manner.

FIG. 1 illustrates key components of an exemplary device that may at least partially provide and/or otherwise be included in an execution environment. The components illustrated in FIGS. 4A-D may be included in or otherwise combined with the components of FIG. 1 to create a variety of arrangements of components according to the subject matter described herein.

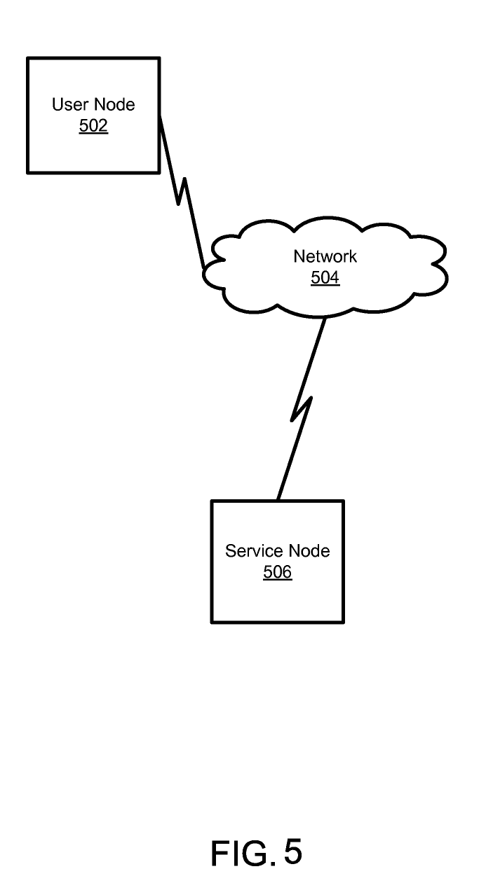

FIG. 5 illustrates a user node 502 as an exemplary device that in various aspects may be included in and/or otherwise adapted to provide any execution environment 401 illustrated in FIGS. 4A-C each illustrating a different adaptation of the arrangement of components in FIG. 3. As illustrated in FIG. 5, user node 502 is operatively coupled to a network 504 via a network interface component, such as network interface adapter 114. A server device is illustrated by a service node 506. Service node 506 may be included in and/or otherwise provide execution environment 401d illustrated in FIG. 4D and/or an analog of execution environment 401d. As illustrated in FIG. 5, service node 506 is operatively coupled to network 504 via a network interface component included in execution environment 401d. Thus, service node 506 is communicatively coupled to one or more user nodes and/or other service nodes. Alternatively or additionally, an adaptation of an execution environment 401 may include and/or may otherwise be provided by a device that is not operatively coupled to a network.

FIG. 4A illustrates that execution environment 401a hosts an application 403a that includes an adaptation of the arrangement of components in FIG. 3. FIG. 4B illustrates execution environment 401b hosting a WEB user agent 403b, such as a browser, including an adaptation of the arrangement of components in FIG. 3 that may operate at least partially in a network application agent 405b received from a remote application provider, such as a network service 403d in FIG. 4D. User agent 403b and execution environment 401b may provide at least part of an execution environment for network application agent 405b that may be received via network 504 from network service 403d operating in service node 506. FIG. 4C illustrates an arrangement of the components in FIG. 3 adapted to operate in a tagging subsystem 407c of execution environment 401c. The arrangement in FIG. 4C may mediate communication between applications 403c and one or more output devices, such as output device 130 in FIG. 1.

FIG. 4D illustrates execution environment 401d hosting one or more network services, such as a web application, illustrated by network service 403d. FIG. 4D also illustrates a network service platform 409d that may provide services to one or more network services. Network service 403d includes yet another adaptation of the arrangement of components in FIG. 3.

As stated the various adaptations of the arrangement in FIG. 3 are not exhaustive. For example, those skilled in the art will see based on the description herein that arrangements of components for performing the method illustrated in FIG. 2 may operate in a single device, or may be distributed across more than one node in a network and/or more than one execution environment. For example, such an arrangement may operate at least partially in user agent 403b illustrated in FIG. 4B and at least partially in execution environment 401d in and/or external to network service 403d.

FIGS. 4A-D illustrate network stacks 411 that operate to send and receive data over network 504, via a network interface component. Network service platform 409d in FIG. 4D provides services to one or more network services. In various aspects, network service platform 409d may include and/or interoperate with a web server. FIG. 4D also illustrates network service platform 409d that interoperates with a network stack 411d.

Communicatively coupled network stacks 411 may support the same protocol suite, such as TCP/IP, or may communicate via a network gateway or other protocol translation device and/or service. For example, user agent 403b in FIG. 4B and network service platform 409d in FIG. 4D may interoperate via their respective network stacks: a network stack 411b and network stack 411d.

FIGS. 4A-D illustrate applications 403, respectively, which may communicate via one or more service protocols. FIGS. 4A-D respectively illustrate service protocol components 413 that operate to communicate via one or more service protocols. Exemplary service protocols include hypertext transfer protocol (HTTP), remote procedure call (RPC) protocols, instant messaging protocols, and presence protocols. Matching protocols enabling applications 403 to communicate via network 504 in FIG. 5 are not required, if communication is via a protocol gateway or other translator.

FIG. 4B illustrates that a user agent may receive some or all of a network application agent in one or more messages sent from a network service, such as network service 403d, via a network service platform 409, a network stack 411, a network interface component, and optionally a service protocol component 413. In FIG. 4B, user agent 403b includes a content manager component 415b. Content manager component 415b may interoperate with one or more of service protocol components 413b and/or network stack 411b to receive the message or messages including some or all of a network application agent 405.

A network application agent 405 may include and/or otherwise may provide access to a web page for presenting a user interface for and/or otherwise based on data from a corresponding network service. The web page may include and/or reference data represented in one or more formats including hypertext markup language (HTML) and/or another markup language, ECMAScript and/or other scripting language, byte code, image data, audio data, and/or machine code.

In an example, in response to a request received from user agent 403b, a controller component 417d, in FIG. 4D, may invoke a model subsystem 419d to perform request-specific processing. Model subsystem 419d may include any number of request handlers (not shown) that operate to dynamically generate data and/or to retrieve data from a model database 421d based on the request. Controller component 417d may further invoke a template engine component 423d to identify one or more templates and/or static data elements to generate a user interface to present a response to the received request. FIG. 4D illustrates a template database 425d including an exemplary template 427d. FIG. 4D illustrates template engine component 423d as a component in a view subsystem 429d that operates to return responses to processed requests in a presentation format suitable for a client, such as user agent 403b. View subsystem 429d may provide the presentation data to controller component 417d to send to user agent 403b in response to the request received from user agent 403b. Some or all of a network application agent may be sent to a user agent via a network service platform, as described above.

While the example describes sending some or all of a network application agent in response to a request, network service 403d additionally or alternatively may send some or all of network application agent 405b to user agent 403b via one or more asynchronous messages. In an aspect, an asynchronous message may be sent in response to a change detected by network service 403d. Publish-subscribe protocols, such as the presence protocol specified by XMPP-IM, are exemplary protocols for sending messages asynchronously.

The one or more messages including information representing some or all of network application agent 405b illustrated in FIG. 4B may be received by content manager component 415b via one or more of service protocol component(s) 413b and network stack 411b as described above. In FIG. 4B, user agent 403b includes one or more content handler components 431b to process received data according to its data type, typically identified by a MIME-type identifier. Exemplary content handler components 431b include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types. Content handler components 431b process received data and may provide a representation of the processed data to one or more user interface (UI) element handler components 433b.

UI element handler components 433 are respectively illustrated in presentation controller components 435 in FIGS. 4A-C. A presentation controller component 435 may manage visual, audio, and/or other types of output of its including application 403 as well as receive and route detected user and other inputs to components and extensions of its including application 403. With respect to FIG. 4B, a UI element handler component 433b in various aspects may be adapted to operate at least partially in a content handler component 431b such as a text/html content handler component and/or a script content handler component. Additionally or alternatively, a UI element handler component 433 in an execution environment 401 may operate in and/or as an extension of its including application 403. For example, a plug-in may provide a virtual machine, for a UI element handler component 433 received as a script and/or byte code, that may operate as an extension in an application 403 and/or external to and interoperating with the application 403.

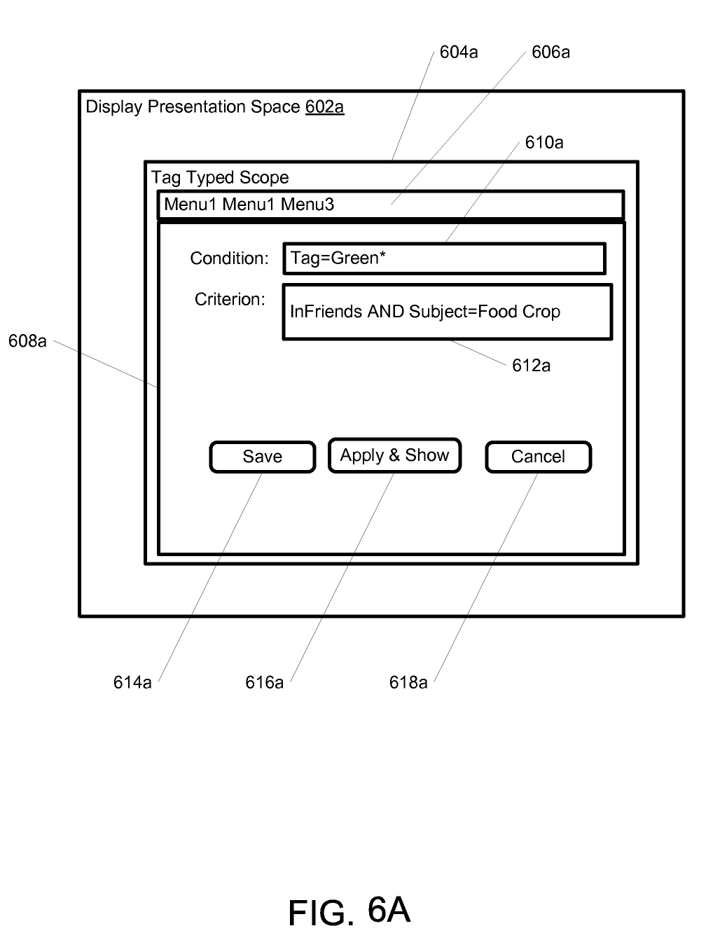

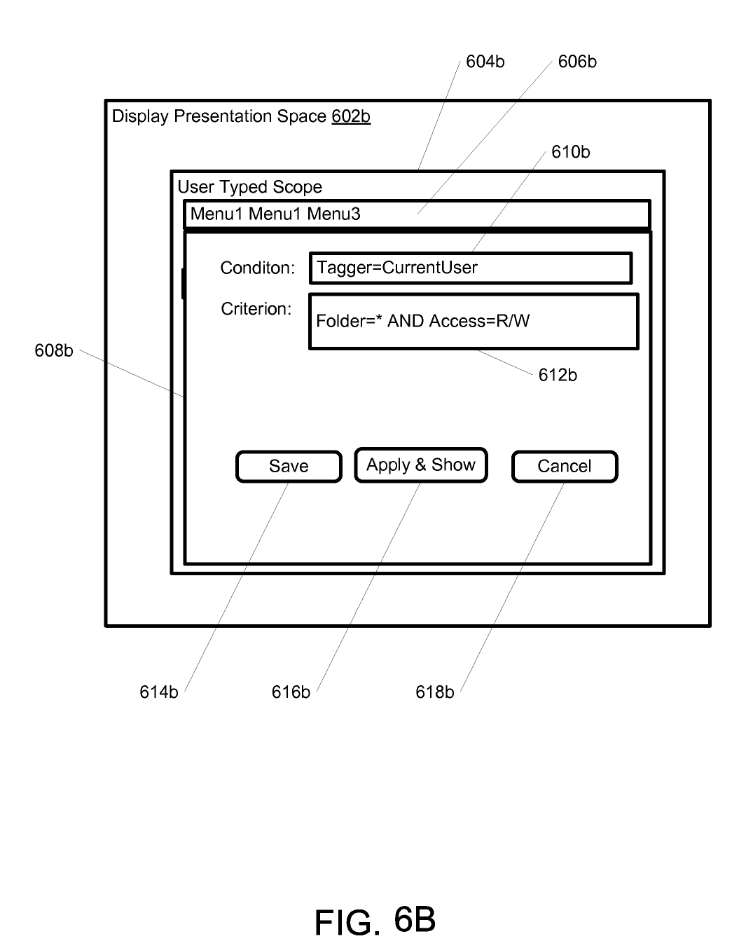

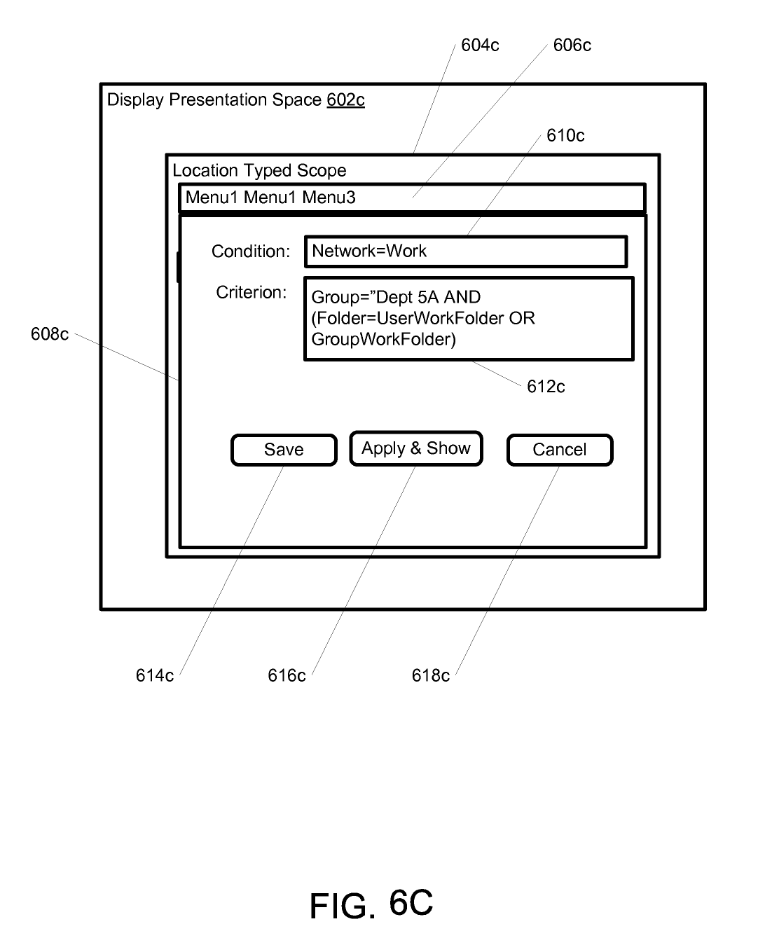

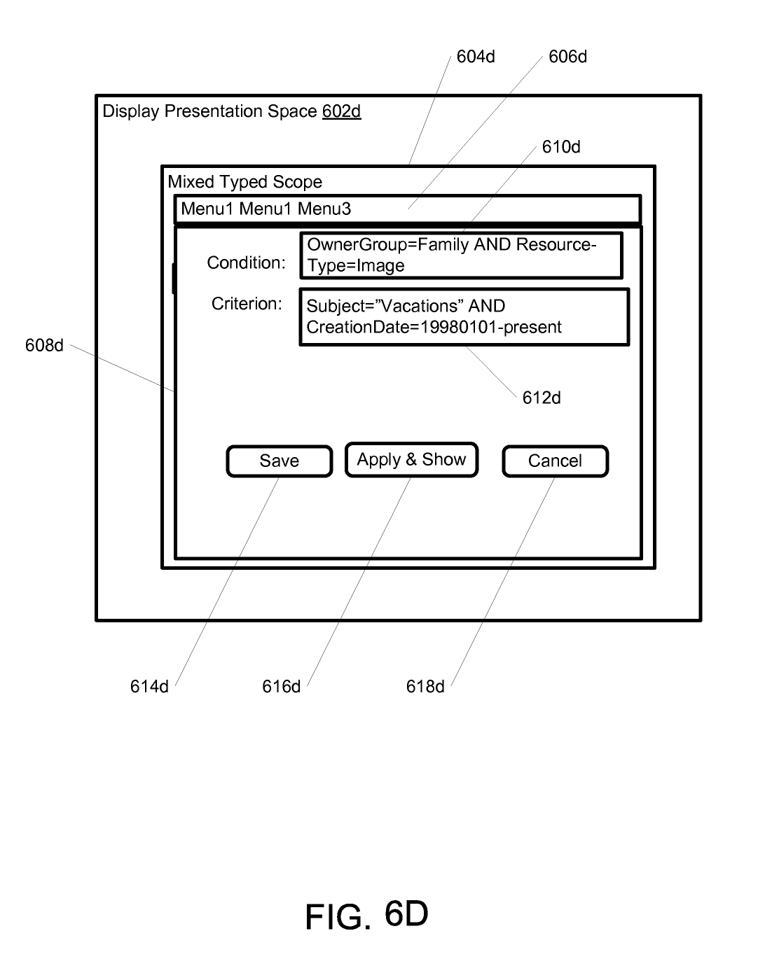

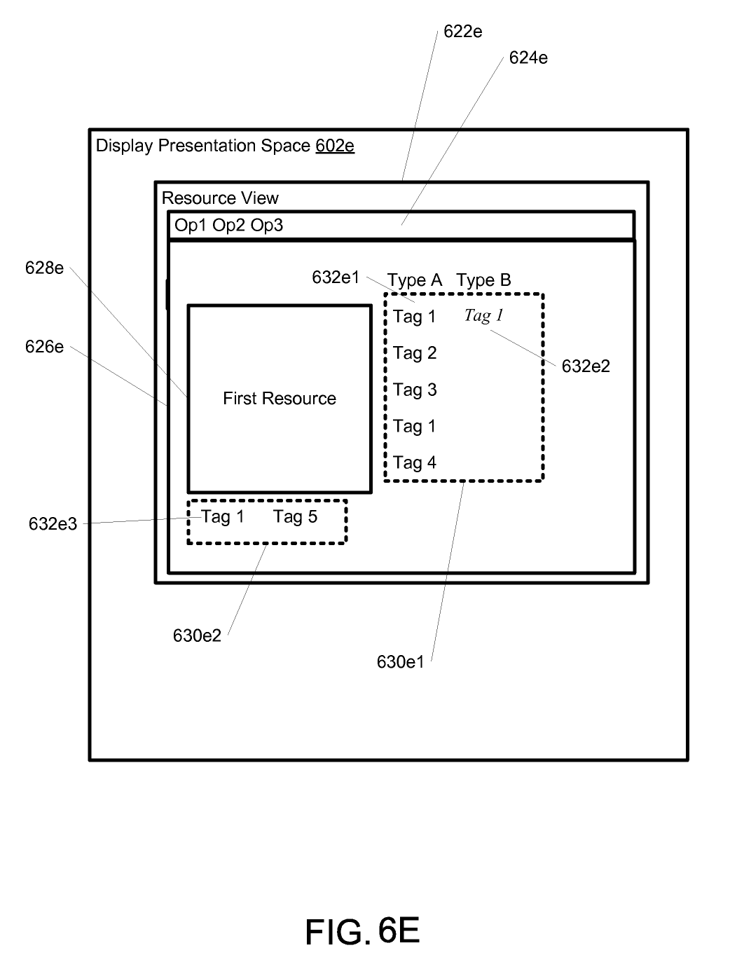

FIGS. 6A-E each respectively illustrates a display presentation space 602 of a display in and/or operatively coupled to node, such as user node 502. FIGS. 6A-E each respectively illustrates various UI elements presented that may provide and/or be included in a user interface for any of applications 403 illustrated in FIGS. 4A-D and/or by a network application agent. For example, a UI element in a user interface may be presented via interoperation of user agent 403b, network application agent 405b, and/or network service 403d. A user agent window may include a user interface of network service 403d operating in service node 506.

Various UI elements of applications 403 described above may be presented by one or more UI element handler components 433 in FIGS. 4A-C and/or by view subsystem 429d as illustrated in FIG. 4D. In an aspect, illustrated in FIGS. 4A-C, A UI element handler component 433 of one or more applications 403 may operate to send presentation information representing a UI element, such as any of the visual components presented in display presentation spaces 602 in FIGS. 6A-E, to a GUI subsystem 437. A GUI subsystem 437 may instruct a graphics subsystem 439 to draw the UI element in a region of a display presentation space 602, based on presentation information received from the corresponding UI element handler component 433.

User input may be received corresponding to a UI element via an input driver 441 illustrated in FIGS. 4A-C in various adaptations. For example, a user may move a mouse to move a pointer presented in a display presentation space 602 over a UI element. A user may provide an input detected by the mouse. The detected input may be received by a GUI subsystem 437 via an input driver 441 as an operation or command indicator based on the association of the shared location of the pointer and the UI element in the display presentation space 602.

A tag and/or a matched tag may be created in response to user input. In various aspects, a tag director component 408 may receive tagging information based on input information from a UI element handler component 433. The user input may be detected that corresponds to a UI element presented for identifying a tag. A tag may be a user entered tag and/or otherwise a user selected tag. For a matched tag, criterion information identifying a tagging criterion may be received via the same or different UI element handler component 433, where the tagging criterion is based on something other than and/or in addition to the identified tag. In another aspect, a tagging criterion may be determined based on a user identified tag, by a UI element handler component 433 and/or by a tag director component 408, in response to a user detected input identifying the tag. The tag director component 408 may create a “matched tag” by creating a tagging association that identifies the tag and the tagging criterion. A tag director component 408 may create a “tag” by creating an entry in an index and/or vocabulary of tags. The tag director component 408 may store the tag and/or tagging association in any suitable memory location(s), such as a storage system illustrated by a tagging store 416. A tagging store may be included in and/or may include some or all of a database, a file system, a disk I/O system, and/or a structure in a processor memory—to name some examples.

Reference is made, herein, to a scope criterion and a scope descriptor defined above. FIGS. 6A-D illustrate various scope criterion some of which are processed as scope conditions to specify various scope descriptors. With reference to FIG. 2, the method may include creating a scope criterion and/or a scope descriptor. Accordingly, a system may include means for creating a scope criterion and/or a scope descriptor. FIGS. 4A-D illustrate scope director components 404 for creating, removing, maintaining, and/or otherwise accessing a scope criterion and/or a scope descriptor, in various aspects A system may include one or more processors and logic encoded in one or more tangible media for execution by the one or more processors that when executed is operable for creating, removing, maintaining, and/or otherwise accessing a scope criterion and/or a scope descriptor, in various aspects.

FIGS. 6A-D depict user interfaces included in receiving user input to specify scope descriptors. The user interfaces in various aspects may be, presented by one or applications 403 as described above for any of FIGS. 4A-D. An application 403 includes one or more UI element handlers 433 to present a scope criterion UI element 604 in a presentation space 602 of a display device. Scope descriptor UI elements 604 are illustrated with a menu bar UI element 606 including input UI elements for receiving user input for various specified operations. Scope descriptor UI elements 604 respectively illustrate input pane UI elements 608 to prompt a user to provide corresponding input to specify condition information to specify a scope condition via a condition UI element 610. In FIG. 6A, a criterion UI element 612 is presented by a corresponding UI element handler component 433a allowing corresponding user input that identifies a scope criterion to be received and/or otherwise detected in addition to the scope condition.

In various aspects, a scope director component 404 may receive condition information based on input information from a UI element handler component 433. In FIGS. 6A-D a UI element handler component corresponding to a condition UI element, such as condition UI element 610a in FIG. 6A may receive “Tag=Green*” specifying that when a resource is tagged with a tag starts with “Green”, an associated scope criterion is active for determining whether the resource is in a scope specified by the scope criterion. A user input may be detected that corresponds a UI element presented to identify and/or otherwise represent a scope criterion, such as criterion UI element 612a in FIG. 6A Scope criterion information identifies a scope criterion, “InFriends AND Subject=Food Crop, which may be defined to indicate that a resource is in the specified scope when the resource is owned by a user having a “friend” relationship with the current user and where the resource has a subject metadata value of “Food Crop”. Condition information and/or scope criterion information may be user entered and/or otherwise user selected. Further, scope criterion information identifying a scope criterion may be received via the same or different UI element handler component 433 which receives the condition information. In creating and/or otherwise identifying a scope descriptor, a scope director component 404 may create a scope descriptor in a memory that identifies a scope criterion and a scope condition that when met indicates that the scope criterion is active.

In an execution environment 401, such as execution environment 401a in FIG. 4A, which may be included in and/or otherwise may include a node, such as user node 502 illustrated in FIG. 5. Condition information identifying a scope condition may be received by a UI element handler component 433a in response to a user input detected by an input driver 441a. Input information, such as information identifying a location in a presentation space of a display, may be provided by the input driver 441a to GUI subsystem 437a. Based on the input information, GUI subsystem 437a may identify application 403a and send the input information, to application 403a. GUI subsystem 437a may provide a component, such as presentation controller 435a that operates to route input information within application 403a to a UI element handler component 433a. The UI element handler component 433a may identify the condition information based on the input information and may provide the condition information to scope director component 404a. Alternatively or additionally, GUI subsystem 437a may provide input information directly to one or more UI element handlers 433a corresponding to one or more UI elements that GUI subsystem 437a has determined correspond to the detected user input. Additional scope criterion information identifying a scope criterion may be received in an analogous manner via the same or different UI element handler component 433a. The UI element handler component 433a may identify the scope criterion information based on the input information and provide the scope criterion information to scope director component 404a. Scope director component 404a may specify and/or otherwise define a resource scope by creating a scope descriptor that identifies the scope condition and the additional scope criterion. The scope descriptor may be stored in scope store 444a, which may include a database record and/or a file.

An arrangement of components in execution environment 401b illustrated in FIG. 4B, may operate to perform equivalently in creating a scope descriptor. Execution environment 401b may also include and/or otherwise be included in a node, such as a user node 502 illustrated in FIG. 5. In FIG. 4B, a UI element handler component 433b and/or a presentation controller component 435b may receive input information corresponding to a presented user interface element for identifying condition information and/or scope criterion information. The input information may be provided to the UI element hander component 433b for processing. The UI element handler component 433b may perform all or some of the processing and/or may send a request to a remote service, such as network service 403d operating in execution environment 401d of a service node 506, via a network, such as network 504. Some or all of the processing of the input information may be performed in execution environment 401d to identify and/or otherwise determine condition information identifying a scope condition. Scope criterion information may be identified and/or otherwise determined analogously. One or more UI element handler components 433b and/or UI element handler components 433d may provide scope condition information and/or other scope criterion information to one or both of scope director component 404b operating in execution environment 401b and/or to scope director component 404d in execution environment 401d to create a scope descriptor.

FIG. 4D illustrates, in an aspect, scope director component 404d in a model subsystem 419d in execution environment 401d which may be included in and/or otherwise may include service node 506 in FIG. 5. A UI element handler component 433b for presenting and/or receiving input identifying condition information and/or a UI element handler component 433b for presenting and/or for receiving input identifying other scope criterion information may operate in user agent 403b in execution environment of user node 502. A message based on the input information corresponding to a UI element presented by the condition information UI element handler component 433b and/or other scope criterion information UI element handler component 433b may be transmitted by user agent 403b to network service 403d operating in execution environment 401d of service node 506 via network 504. Scope director component 404d may be invoked in response to the message by a request handler (not shown) in model subsystem 419d. Scope director component 404d may receive condition information and/or otherwise may identify condition information based on the message. User agent 403b and/or network application agent 405b may send the message via user node 502 communicatively coupled to network 504 to service node 506 for delivery to network service 403d. Controller component 417d may receive at least some portion of the message. Based on the message or portion thereof, such as a URI, controller component 417d may route information in the message to a request handler (not shown) in model subsystem 419d. Scope director component 404d may include, may be included in, and/or may otherwise interoperate with the request handler identified by controller component 417d. Scope director component 404d may identify a condition based on the condition information received and/or otherwise identified. Scope director component 404d may alternatively or additionally identify other scope criterion analogously, based on input detected by user agent 403b in execution environment 401b of user node 502. Scope director component 404d may create a scope descriptor identifying the scope condition and/or other scope criterion. For example, in an aspect, scope director component 404d may store a scope descriptor for the matched tag in one or more records and/or locations in scope store 445d.

The arrangement of components operating in execution environment 401c, illustrated in FIG. 4C, may also perform the operations described above and/or analogous operations. Execution environment 401c and/or analog of execution environment 401c may be provided by and/or otherwise my include one or more nodes, such as a user node 502. Input processing in execution environment 401c in FIG. 4C may be performed for more than one application 403c by a subsystem illustrated by tagging subsystem 407c. In an aspect, a UI element handler component 433c and/or a presentation controller component 435c operating in an application 403c may receive input information corresponding to a presented item to identify condition information and/or to identify other scope criterion information. The UI element handler component 433c may operate in an application, such a first application 403c1 or a second application 403c2 as shown in FIG. 4C. Alternatively or additionally, an application 403c may interoperate with a UI element handler component, provided by tagging subsystem 407c. A UI element handler 433c1 in first application 403c1 may interoperate with a UI element handler component in tagging subsystem 407c in receiving input information to provide condition information and/or other scope criterion information to scope director component 404c. A user input may be detected by an input driver 441c. Input information, such as information identifying a location with respect to a presentation space, may be provided by the input driver 441c to a GUI subsystem 437c. Based on the input information, GUI subsystem 437c may identify an application 403c and send selection information, based on the input information, to the application 403c. GUI subsystem 437c may provide input information to a component, such as a presentation controller 435c1 to route the input information within first application 403c1 for processing. Alternatively or additionally, GUI subsystem 437c may provide input information directly to one or more UI element handlers 433c corresponding to one or more UI elements that GUI subsystem 437c determines correspond to the detected user input. Scope director component 403c creates a scope descriptor identifying the scope condition and/or other scope criterion. For example, in an aspect, scope director component 404d may store a scope descriptor to realize and/or otherwise represent a resource scope in a storage location in a processor memory and/or in a persistent secondary storage location in scope store 445c.

With reference to FIG. 2, a block 202 illustrates that the method includes detecting a first tag that tags at least one resource. Accordingly, a system for locating tagged resources in a resource scope includes means for detecting a first tag that tags at least one resource. For example, the arrangement in FIG. 3, includes tagging component 302 that is operable for detecting a first tag that tags at least one resource. FIGS. 4A-D illustrate tagging components 402 as adaptations and/or analogs of the tagging component 302 in FIG. 3. One or more tagging components 402 operate in an execution environment 401. The system for locating tagged resources in a resource scope includes one or more processors and logic encoded in one or more tangible media for execution by the one or more processors that when executed is operable for detecting a first tag that tags at least one resource.

In FIG. 4A, a tagging component 402a is illustrated as a component of application 403a. In FIG. 4B, a tagging component 402b is illustrated as a component of network application agent 405b. In FIG. 4C, a tagging component 402c is illustrated operating external to one or more applications 403c. Execution environment 401c includes a tagging component 402c in a tagging subsystem 407c. In an aspect tagging component 402b and tagging component 402d communicate via user agent 403b and network service 403d in performing a portion of the method illustrated in FIG. 2 in block 202.

With respect to FIGS. 4A-D, a tagging component 402 may create, modify, remove, access and/or otherwise detected a tag that tags a resource. The tag may be identified by a matched tag as defined and described above. A tagging component, in one aspect, may detect a tag that tags a resource in creating a tagged association and/or in accessing a tagged association from a memory location, such as a location in a tagged store 414. The tagging component 402 may determine that a tagged association identifies a tag and/or a matched tag and a resource tagged with the tag and/or the matched tag. A tagging component 402 may be invoked to identify one or more tags that tag a resource in response to an access to a resource, an identifier of a resource, and/or an attribute of a resource.

In FIG. 4A, tagging component 402a may determine and/or identify a tag and/or a matched tag that tags a resource in response to a user input detected by an input device. The user input may correspond to a UI element, presented via an output device by a UI element handler component 433a, and that represents and/or otherwise identifies a resource. The UI element handler component 433a associated with the presented UI element may receive input information that identifies the resource. In response, the UI element handler component 433a may identify the resource to tagging component 402a. Tagging component 402a may locate and/or otherwise identify one or more tagged associations that respectively identify a tag and/or a matched tag that tags the resource.

Alternatively or additionally, a tag director component 408 may operate to create, delete, and/or otherwise maintain one or more tagging-attribute associations, defined above. In FIG. 4B, a tag director component 408b may store a tagging-attribute association in a memory location, which may be volatile, and/or in a memory location that may be persistent. Tag director component 408b may operate in an execution environment 401b of a user node 502 to communicate via network 504 with a network service 403d in an execution environment 401d of a service node 506 to store a tagging-attribute association in a location in a tagged store 414d, a tagging store 416d, and/or any other storage accessible to execution environment 401d. Tag director component 408b, in FIG. 4B, may interoperate with tag director component 408d to create, delete, update, and/or otherwise maintain the tagging-attribute association. A change to an attribute may be reported to tag director component 408b. Tag director component 408b may identify one or more matched tags that identify tagging criterion based on the changed attribute. Tag director component 408b may interoperate with tagging component 402b and/or tagging component 402d to identify one or more resources tagged with tags respectively identified by the one or more matched tags.

In yet another aspect, detecting a tag that tags a resource may include tagging the resource. With respect to FIG. 4A-D, a tag director component 408 may interoperate with a tagging component 402 to dynamically tag a resource, in response to accessing and/or otherwise identifying the resource. A tag may be identified by a matched tag. Detecting a tag that tags a resource may include determining that a tagging criterion, identified by the matched tag, is met for the resource. Detecting the tag may include tagging the resource with the tag identified by the matched tag, in response to determining the tagging criterion is met.

Alternatively or additionally, for a matched tag, tagging may be performed in response to receiving criterion information identifying a tagging criterion identified by the matched tag that identifies the tag. When a tagging criterion is met for a resource, as determined by a criterion match component 412, a tagging component 402 may tag the resource with the matched tag; and thus detect the tag and the matched tag that tags the resource. In FIG. 4C, at the direction of tagging component 402c, tag director component 408c may retrieve and/or otherwise identify a first tagging criterion in a first matched tag. The first tagging criterion may be provided to and/or otherwise may be identified to criterion match component 412c, by tag director component 408c and/or by tagging component 402c. Criterion match component 412c may determine that the first tagging criterion is met for the resource. In response, tagging component 402c may operate to tag the resource with the first matched tag that includes the first tagging criterion. Tagging may be performed in response to receiving tagging information that identifies the tag. For example, tagging information may be received from a user by a UI element handler component 433c.

In still another aspect, detecting a tag that tags a resource may include receiving an input indication to perform a search for one or more resources tagged with a specified tag. With respect to FIG. 4A-D, a tagging component 402 may create and otherwise receive information identifying a tag and/or a matched tag and a resource for storing a tagged association in any suitable way and at any suitable time. For example, a tag handler component 410 may be invoked in response to a user input corresponding to a tag represented via an output device. The tagging component 402 may operate to locate one or more resources tagged with the tag. As result, the tagging component 402 may identify one or more tagged associations that identify the tag. Each of the one or more tagged associations identifies a resource, thus the tagging component 402 detects a tag that tags one or more resources.

Returning to FIG. 2, a block 204 illustrates that the method further includes identifying a first scope descriptor for the first tag. Accordingly, a system for locating tagged resources in a resource scope includes means for identifying a first scope descriptor for the first tag. For example, the arrangement in FIG. 3, includes scope director component 304 that is operable for identifying a first scope descriptor for the first tag. FIGS. 4A-D illustrate scope director components 404 as adaptations and/or analogs of scope director component 304 in FIG. 3. One or more scope director components 404 operate in an execution environment 401. The system for locating tagged resources in a resource scope includes one or more processors and logic encoded in one or more tangible media for execution by the one or more processors that when executed is operable for identifying a first scope descriptor for the first tag.

Further in FIG. 2, a block 206 illustrates that the method yet further includes identifying a second scope descriptor for the first tag. Accordingly, a system for locating tagged resources in a resource scope includes means for identifying a second scope descriptor for the first tag. For example, the arrangement in FIG. 3, includes scope director component 304 that is operable for identifying a second scope descriptor for the first tag. FIGS. 4A-D illustrate scope director components 404 as adaptations and/or analogs of scope director component 306 in FIG. 3. One or more scope director components 404 operate in an execution environment 401. The system for locating tagged resources in a resource scope includes one or more processors and logic encoded in one or more tangible media for execution by the one or more processors that when executed is operable for identifying a second scope descriptor for the first tag.

In FIG. 4A, a scope director component 404a is illustrated as a component of application 403a. In FIG. 4B, a scope director component 404b is illustrated as a component of network application agent 405b. In FIG. 4C, a scope director component 402c is illustrated operating external to one or more applications 403c. Execution environment 401c includes a scope director component 404c in tagging subsystem 407c. In an aspect scope director component 404b and scope director component 404d communicate via user agent 403b and network service 403d in performing a portion of the method illustrated in FIG. 2 in block 204 and/or in block 206.

As described above, a tag handler component 410 may be invoked, in response to a user input that targets and/or that otherwise corresponds to a tag UI element, representing and/or otherwise identifying a first tag, presented by the tag handler component 410. The tag handler component 410 may process information received in response to the user input as selection information and may identify the first tag represented by the tag UI element. A tagging component 402 may, based on identification of the first tag by the tag handler component 410, invoke and/or otherwise interoperate with a scope director component 404 to determine that the first tag is included in and/or otherwise identified by a scoped tag that associates the tag with a scope descriptor. Scope director component 404 may identify and/or locate the scope descriptor associated with the tag based on any suitable information available. For example, scope director component 404 may identify the scope descriptor by locating a scoped tag stored in in a memory location. The first tag may be identified by one or more matched tags. The scope director component 404 may identify a scoped tag identifying a first matched tag and a first scope descriptor, when the first matched tag is identified. The scope director component 404 may identify a scoped tag identifying a second matched tag and a second scope descriptor, when the second matched tag is identified. The second matched tag may also identify the first tag.

In another aspect, a scope descriptor may be identified based on a user. With respect to FIG. 4A-D, first selection information may be received from an identified first user. A scope condition that is met based on the first user may be located in identifying a scope descriptor that includes and/or otherwise identifies the scope condition. A scope director component 404 may identify a first scope condition identified by a first scope descriptor. The first scope condition may be specified, for example, to be met when the current user, the first user, is the creator of a tagging of a resource with the first tag. Whether the first scope descriptor is active and/or whether a first scope criterion, that may be identified by the first scope descriptor, is met for a resource may or may not depend on who tagged the particular resource, in various aspects. The first tag may be in a first matched tag or not. Similarly, second selection information received from an identified second user may identify the first tag that tags a second resource. Scope director component 404 may identify a second scope descriptor based on the second user as determined by a second scope condition in a second scope descriptor. The second scope condition may be based on the same or different type of relationship to the second resource as the first resource had to the first user. The second scope descriptor may be identified as active by the scope director component 404 based on the relationship of the second user to the second resource which determines whether the second scope condition is met.

With reference to FIG. 6E and FIG. 4A, each tag UI element 632e may be presented by a respective tag handler component 410a. Thus user input that corresponds to first tag UI element 632e1 may be directed to a corresponding first tag handler component 410a. User input that corresponds to second tag UI element 632e2, in the aspect, is directed to a corresponding second tag handler component 410a. The first tag handler component 410a may include and/or otherwise have access to a parameter that identifies and/or otherwise associates the first matched tag with the first tag UI element 632e1. The second tag handler component 410a may include and/or otherwise have access to a parameter that identifies and/or otherwise associates the second matched tag with the second tag UI element 632e2. In response to a user input corresponding to first tag UI element 632e1, first tag handler component 410a may operate to identify the first matched tag to a scope director component 404a. In response to a user input corresponding to second tag UI element 632e2, second tag handler component 410a may operate to identify the second matched tag to scope director component 404a. Scope director component 404a may process the identified first matched tag to identify a first scope descriptor associated with the first tag based on the first matched tag. In an aspect, scope director component 404a may locate a scoped tag based on the first tag, in order to locate the first scope descriptor. Scope director component 404a may process the identified second matched tag to identify a second scope descriptor that identifies a second scope condition that is met or not met based on the second matched tag, in an analogous manner

In FIG. 4B, tag handler component 410b may interoperate with a content handler component 431b to send a message to network service 403d. The message may include a request for a first resource and/or a first tag that tags the first resource. Controller component 417d may route the request to a request handler (not shown) to in model subsystem 419d. The request handler in model subsystem 419d may invoke tag handler component 410d to generate presentation information to present the tag along with and/or otherwise corresponding to a representation of the first resource. Tag handler component 410d may send the presentation information via controller component 417d in a message to user agent 403b. The presentation information in the message may be provided to a suitable content handler component 431b to interoperate with tag handler 410b and/or UI element handler 433b to present a UI element that represents and/or otherwise identifies the first tag along with a UI element that represents and/or otherwise identifies of the first resource as described above. Tag handler component 410b may operate to process input information from a user. Tag handler component 410b may operate to invoke scope director component 404b and/or scope director component 404d operating in execution environment 401d of a service node 506. The invocation may be direct or indirect. One of the scope director components or both of the scope director components may locate and/or otherwise identify, based on the first resource, a first scope descriptor. In an aspect, scope director component 404b may identify one or more active scope descriptors by identifying one or more respective scope conditions that are currently met. A scope condition may be based on a resource, such as the first resource tagged with the first tag. With respect to FIG. 6D, information specifying a scope descriptor is received via the scope descriptor UI element 604d. The specified scope condition is based on an resource in the role of condition entity. The scope condition is based on the type of entity. The entity has a type that matches “Image”. The first resource may be an image with a group owner of “Family”. A type and group owner of an entity are examples of attributes of an entity. Thus, whether a scope condition is met or not may be based on an attribute of a condition entity. The scope condition may be determined and/or otherwise identified as met by scope director component 404b. Thus the scope descriptor specified via scope descriptor UI element 604d may be identified by scope director component 404b as active.

The same and/or a different tag handler component 410b may operate to present the first tag and along with a representation of a second resource tagged with the first tag. Presentation information may be provided by tag handler component 410b to present a UI element that represents and/or otherwise identifies the first tag along with a UI element that represents and/or otherwise identifies the second resource as described above. Tag handler component 410b may operate to process input information from a user. Tag handler component 410b may operate to invoke scope director component 404b and/or scope director component 404d. As described above with respect to the first matched tag, one or both of the scope director components may locate and/or otherwise identify, based on the second resource, a second scope descriptor.

Identifying a scope descriptor may include exchanging a message via a network with a remote execution environment. The message may identify a scope descriptor, a tag for which the scope descriptor identifies a scope, and/or a resource tagged with the tag. In a further aspect, a message may be a sent to or received from the remote execution environment. A message exchanged in identifying a scope descriptor may include a request and/or a response. With respect to FIG. 4B and FIG. 4D, tag and resource information may be sent from browser 403b in an execution environment 401b of a user node 502 to a scope director component 404d in a network service 403d operating in an execution environment 401d of a service node 506. The message may be a request sent by network 504. A response identifying a scope descriptor may be sent by the network service 403b to the browser. In another aspect, a message may be sent to network service 403d that identifies a scope descriptor identified by a scope director component 404b.

With respect to FIG. 4C, a tag handler component 410c may operate to process input information from a user that corresponds to a UI element that represents and/or otherwise identifies a first tag. The user may be in and/or otherwise may be associated with a first location. Tag handler component 410c may interoperate with a scope director component 404c to locate and/or otherwise identify a first scope descriptor based on the first location. For example, an active scope descriptor may be identified based on identifying a scope condition that is met based on the first location. FIG. 6C illustrates information specifying a location based scope condition via condition UI element 610c in scope descriptor UI element 604c. When the user is accessing a network identified as “Work”, the condition is met as determined by scope director component 404c. Access to the “Work” network identifies a network and/or may identify a geospatial location. Tagging subsystem 407c may provide services for multiple applications 403c, and in an aspect may allow multiple applications to share tags, matched tags, tagging criteria, scope descriptors, and/or resources. Similarly, tag handler component 410c may operate to process input information from a user that corresponds to a UI element that represents and/or otherwise identifies the first tag. The user may be in and/or otherwise associated with a second location. Tag handler component 410c may interoperate with scope director component 404c to locate and/or otherwise identify a second scope descriptor based on the second location.

Returning to FIG. 2, a block 208 illustrates that the method yet further includes determining a first set of resources that are in a first resource scope specified by the first scope descriptor and that are tagged with the first tag. Accordingly, a system for locating tagged resources in a resource scope includes means for determining a first set of resources that are in a first resource scope specified by the first scope descriptor and that are tagged with the first tag. For example, the arrangement in FIG. 3, includes scope match component 306 that is operable for determining a first set of resources that are in a first resource scope specified by the first scope descriptor and that are tagged with the first tag. FIGS. 4A-D illustrate scope match components 406 as adaptations and/or analogs of scope match component 306 in FIG. 3. One or more scope match components 406 operate in an execution environment 401. The system for locating tagged resources in a resource scope includes one or more processors and logic encoded in one or more tangible media for execution by the one or more processors that when executed is operable for determining a first set of resources that are in a first resource scope specified by the first scope descriptor and that are tagged with the first tag.

Also in FIG. 2, a block 210 illustrates that the method yet further includes determining a second set of resources that are in a second resource scope specified by the second scope descriptor and that are tagged with the first tag, wherein a third resource tagged with the first tag is included in one of the first set and the second set. Accordingly, a system for locating tagged resources in a resource scope includes means for determining a second set of resources that are in a second resource scope specified by the second scope descriptor and that are tagged with the first tag, wherein a third resource tagged with the first tag is included in one of the first set and the second set. For example, the arrangement in FIG. 3, includes scope match component 306 that is operable for determining a second set of resources that are in a second resource scope specified by the second scope descriptor and that are tagged with the first tag, wherein a third resource tagged with the first tag is included in one of the first set and the second set. FIGS. 4A-D illustrate scope match components 406 as adaptations and/or analogs of scope match component 308 in FIG. 3. One or more scope match components 406 operate in an execution environment 401. The system for locating tagged resources in a resource scope includes one or more processors and logic encoded in one or more tangible media for execution by the one or more processors that when executed is operable for determining a second set of resources that are in a second resource scope specified by the second scope descriptor and that are tagged with the first tag, wherein a third resource tagged with the first tag is included in one of the first set and the second set.

In FIG. 4A, a scope match component 406a is illustrated as a component of application 403a. In FIG. 4B, a scope match component 406b is illustrated as a component of network application agent 405b. In FIG. 4C, a scope match component 406c is illustrated operating external to one or more applications 403c. Execution environment 401c includes a scope match component 406c in tagging subsystem 407c. In an aspect scope match component 406b and scope match component 406d communicate via user agent 403b and network service 403d in performing a portion of the method illustrated in FIG. 2 in block 208 and/or in block 210

With respect to FIG. 2, determining the first set may include determining whether a resource in the first scope is tagged with the first tag. The resource may be included in the first set when the resource is tagged with the first tag and not included in the first set otherwise. Determining whether the resource is tagged with the first tag may include searching for a tagged association that identifies the first tag and the resource. In another aspect, determining whether the resource is tagged with the first tag may include determining whether a tagging criterion, identified by a matched tag that identifies the first tag, is met for the resource. The resource may be tagged in response to determining that the tagging criterion is met. The preceding statements apply in an analogous manner to the second set identified in FIG. 2.

Referring again to FIGS. 4A-D and as described above, a tag handler component 410 may be invoked, in response to a user input that targets and/or that otherwise corresponds to a tag UI element, representing and/or otherwise identifying a first tag, presented by the tag handler component 410. The tag handler component 410 may process information received in response to the user input as selection information and may identify a particular tag also represented and/or otherwise identified by the tag UI element. A tagging component 408, based on identification of the tag by the tag handler component 406, may lookup and/or otherwise identify resources tagged with the tag, as described above. When the tag is identified by a matched tag also represented and/or otherwise identified by the tag UI element, a tagging component 402 may likewise lookup and/or otherwise identify one or more resources tagged with the tag where the tagging criterion, identified by the matched tag and as determined by a criterion match component 412, is met for each of the resources, if any. One or more resources may be identified by a tagging component 402 operating to locate and/or otherwise identify one or more tagged associations. A scope match component 406 may receive and/or otherwise may be provided access to a first scope descriptor that identifies a first scope criterion identified, as described above. The scope match component 406 may determine a set of resources tagged with the tag and/or the matched tag that are in a first scope specified by a first scope descriptor associated with the tag and/or the matched tag. For a scope descriptor based on a type of a user, first selection information received from an identified first user may identify a first tag that tags a first resource. The first tag may be associated with a first scope descriptor, by a scope director component 404 based on the identified first user. The tag may be in a matched tag or not. Similarly, second selection information received from an identified second user may identify the first tag that tags the first resource. The first tag may be associated with a second scope descriptor, by the scope director component 404 based on the identified second user.

Returning to FIG. 2, in an aspect, determining the first set may include determining whether a first scope criterion identified by the first scope descriptor is met for a resource tagged with the first tag. The resource is included in the first set when the first scope criterion is determined to be met and not included in the first set otherwise. The preceding statements apply in an analogous manner to the second set identified in FIG. 2.

For example, scope criterion information specified in criterion UI element 612b in FIG. 6B, specifies that a resource is in a scope specified by the scope criterion information when the resource is in a folder and the accessing user has at least read/write authorization. When the scope match component 406 determines that the scope criterion is met for a particular resource tagged with the first tag, the scope match component 406 includes the resource in a first set, provided the scope condition is also met. When the scope match component 406 determines that the scope criterion is not met for the particular resource, the scope match component 406 does not include the resource in the set. Note that the scope criterion is active for a resource, in this example, when the current user tagged the resource with the tag. Thus the scope criterion is active or not based on resource, tag pairs. It may be inactive for one resource, tag pair and active for another.

A scope match component 406 may operate, based on the first selection information, to identify resources, tagged with the first tag, for which the first scope descriptor is met. Such resources define a first resource set. The scoped tag component 406 operates, based on the second selection information, to identify resources, tagged with the first tag, for which the second scope descriptor is met, defining a second resource set. In some instances, the first set and the second set may identify equal sets. In other instances, the first set may be subset of the second set and/or the first and second sets may include a non-empty intersection. In still other cases, the first set and the second set my be disjoint meaning their intersection is empty. When the first set and the second set are not equal, at least one of the two sets includes a resource not in the other resource set.

With reference to FIG. 6E and FIG. 4A, each tag UI element 632e may be presented by a respective tag handler component 410a. Thus user input that corresponds to first tag UI element 632e1 is directed to a corresponding first tag handler component 410a. User input that corresponds to second tag UI element 632e2, in the aspect, is directed to a corresponding second tag handler component 410a. The first tag handler component 410a may include and/or otherwise have access to a parameter that identifies and/or otherwise associates the first matched tag with the first tag UI element 632e1. The second tag handler component 410a may include and/or otherwise have access to a parameter that identifies and/or otherwise associates the second matched tag with the second tag UI element 632e2. In response to a user input corresponding to first tag UI element 632e1, first tag handler component 410a and/or scope director component 404a may operate to identify the first matched tag and an identified first scope descriptor to a scope match component 406a. In response to a user input corresponding to second tag UI element 632e2, second tag handler component 410a and/or scope director component 404a may operate to identify the second matched tag and a second scope descriptor to scope match component 406a. Scope match component 406a may process the identified first scope descriptor to locate one or more resources for which a first scope criterion in the first scope descriptor is met. Tagging component 402a may interoperate with scope match component 406a to identify resources for which the first scope criterion is met that are tagged with the first matched tag. Tagging component 402a may interoperate with criterion match component 412a to determine whether a first tagging criterion identified by the first matched tag is met for a resource in the first scope in determining whether the resource is tagged with the first matched tag and in the first scope. Resources identified as tagged with the first matched tag and identified as in the first scope are included in a first set. Scope match component 406a may process the identified second matched tag to identify a second scope descriptor associated with the first tag based on the second matched tag. Scope match component 406a may operate to locate one or more resources for which the second scope descriptor is met. Tagging component 402a may interoperate with scope match component 406a to identify resources for which a second scope criterion identified by the second scope descriptor is met that are tagged with the second matched tag. Tagging component 402a may interoperate with criterion match component 412a to determine whether a second tagging criterion identified by the second matched tag is met for a resource in the second scope in determining whether the resource is tagged with the second matched tag and in the second scope. Resources identified as tagged with the second matched tag and identified as in the second scope are included in a second set. In an aspect the first resource may be excluded from both sets in which case the first set and the second set may each include zero or more resources. In FIG. 4A, in an aspect, scope match component 406a may operate to invoke a search component (not shown) to perform a search based on one or more a scope criterion in a scope descriptor in identifying a set.

In an aspect, tag handler component 410b may interoperate with a content handler component 431b to send a message to network service 403d. The message may include a request for a first resource and/or a first tag that tags the first resource. Controller component 417d may route the request to a request handler (not shown) to in model subsystem 419d. The request handler in model subsystem 419d may invoke tag handler component 410d to generate presentation information to present the tag along with and/or otherwise corresponding to a representation of the first resource. Tag handler component 410d may send the presentation information via controller component 417d in a message to user agent 403b. The presentation information in the message may be provided to a suitable content handler component 431b to interoperate with tag handler 410b and/or UI element handler 433b to present a UI element that represents and/or otherwise identifies the first tag along with a UI element that represents and/or otherwise identifies of the first resource as described above. Tag handler component 410b may operate to process input information from a user. Tag handler component 410b may operate to invoke scope match component 406b and/or scope match component 406d operating in execution environment 401d of a service node 506. The invocation may be direct or indirect. One of the scope match components or both of the scope match components may locate and/or otherwise identify one or more other resources tagged with tag and stored in a data store of execution environment 401b and/or in a data store of execution environment 401d that meet a first scope descriptor identified based and/or evaluated based on the first resource. Such resources are included in a first set by scope match component 406b and/or by scope match component 406d. The same and/or a different tag handler component 410b may operate to present the first tag and along with a representation of a second resource tagged with the first tag. Presentation information may be provided by tag handler component 410b to present a UI element that represents and/or otherwise identifies the first tag along with a UI element that represents and/or otherwise identifies of the second resource as described above. Tag handler component 410b may operate to process input information from a user. Tag handler component 410b may operate to invoke scope match component 406b and/or scope match component 406d operating in execution environment 401d of a service node 506. The invocation may be direct or indirect. One of the scope match components or both of the scope match components may locate and/or otherwise identify one or more other resources tagged with tag and stored in a data store of execution environment 401b and/or in a data store of execution environment 401d that meet a second scope descriptor identified based and/or evaluated based on the second resource. Such resources are included in a second set by scope match component 406b and/or by scope match component 406d.

Tag handler component 406c may operate to process input information from a user that corresponds to a UI element that represents and/or otherwise identifies a first tag. The user may be in and/or otherwise associated with a first location. Tag handler component 406c may operate to locate another resource tagged with the first tag for which a first scope descriptor is met as determined by a scope match component 408c in tagging subsystem 407c. The first scope descriptor may be identified by a scope director component 404c based on the first location. Alternatively or additionally, the first scope descriptor may be evaluated based on the first location to determine whether it is met for a resource tagged with the first tag. When the first scope descriptor is met for the resource, the resource is included in a first set by scope match component 408c. Similarly, tag handler component 406c may operate to process input information from a user that corresponds to a UI element that represents and/or otherwise identifies a first tag. The user may be in and/or otherwise associated with a second location. Tag handler component 406c may operate to locate another resource tagged with the first tag for which a second scope descriptor is met as determined by scope match component 408c in tagging subsystem 407c. The second scope descriptor may be identified by a scope director component 404c based on the second location. Alternatively or additionally, the second scope descriptor may be evaluated based on the second location to determine whether it is met for a resource tagged with the first tag. When the second scope descriptor is met for the resource, the resource is included in a second set by scope match component 408c.

Creating a scope descriptor may include identifying a scope criterion in response to a user input detected by an input device, wherein a UI element corresponding to the user input is associated with scope condition. Creating the scope descriptor may further include associating the scope criterion with the scope condition based on the association between the UI element and the scope condition. In an aspect, the first scope criterion may be identified as active in response to determining that an associated scope condition is met. With respect to the method in FIG. 2 the first scope criterion may be identified based on a first scope condition via a first scope descriptor and the second scope criterion may be identified based on a second scope condition identified by a second scope descriptor. A scope director component may operate to identify a scope criterion.

In an aspect, a first set may be determined based on first scope descriptor with a first scope condition that is met based a first condition entity and the first condition entity's first type. A second set may be determined based on second scope descriptor with a second scope condition that is met based a second condition entity and the second condition entity's second type. A second set may be determined that includes the first condition entity. A first set may be determined that includes the second condition entity. In a further aspect, the first set may not include the first condition entity and/or the second set may not include the second condition entity. Still further, the first scope descriptor and the second scope descriptor may both identify a third condition entity. In another aspect, the first condition entity may be tagged with the first tag and/or the second condition entity may be tagged with the first tag. In a further aspect, whether the first scope condition is met and whether the second scope condition is met may be based on an condition entity's third type that may be different than the type of the first condition entity and/or the type of the second condition entity.

The method illustrated in FIG. 2 may include additional aspects supported by various adaptations and/or analogs of the arrangement of components in FIG. 3.

As described above, identifying a scope descriptor may include detecting an input corresponding to a tag UI element, presented to a user via an output device, that represents and/or otherwise identifies the tag. The scope descriptor may be identified in response to detecting the input. In an aspect, the scope descriptor may be identified based on an attribute of a condition entity. The scope descriptor may be identified by detecting a scope condition that is met. The scope condition is included in the scope descriptor, which is identified based on detecting that the scope condition is met. The scope condition may be evaluated based on the attribute and is, thus, met based on the first attribute. The scope condition may be located and/or otherwise in location in a memory. The scope descriptor may also be located in the memory location. The memory location may be contiguous or not. The memory location may be included in persistent memory and/or in volatile memory. Exemplary condition entities may include a file, a document, a record, text data, image data, streaming data, audio data, time-based data, location based data, a matched tag, and/or a user. A condition entity may include a resource tagged with tag. The tag may be identified by a scoped tag.

As described above a scope descriptor may be identified by determining that a scope condition in the scope descriptor is met. Thus, with respect to FIG. 2, identifying the first scope descriptor may include determining that the first scope condition is met. Alternatively or additionally, identifying the second scope descriptor may include determining, based on a second condition entity, that a second scope condition identified by the second scope descriptor is met. Also as described above, determining that a scope condition is met may be based on an attribute of a condition entity. As such, with respect to FIG. 2, determining that the first scope condition is met may be based on a first attribute of the first condition entity. Alternatively or additionally, determining that the second scope condition is met may be based on a second attribute of the first condition entity.

In an aspect, identifying a scope descriptor may include detecting a change to an attribute included in determining whether a scope condition in the scope descriptor is met. In FIG. 6A and with respect to FIGS. 4A-D, a scope condition is specified that indicates it is met in the context of one or more resources tagged with the tag “Green”. A tagging component 402 may detect a tagging of a resource with the “Green” tag. A scope match component 406 may operate in response to tagging component 402 detecting the tagging. The scope match component 406 may determine that the scope condition for the scope descriptor specified in scope descriptor UI element 604a is active. For the tagged resource, the scope descriptor is identified for determining and/or otherwise updating a set of resources tagged with a tag “Green” that is included in specifying the resource scope for the set. A scope criterion specified in criterion UI element 612a is also included in specifying the resource scope. Thus, with respect to FIG. 2, identifying the first scope descriptor may include detecting a change to a first attribute and identifying the second scope descriptor may include detecting a change to a second attribute. An attribute for a condition entity may include metadata for the condition entity. Thus different scope conditions may be identified based on different metadata for a same condition entity and/or for different condition entities.

In another aspect, a resource may be previously determined to be in a resource scope defined by a scope descriptor. Determining the set of resources in the resource scope tagged with a specified tag may include determining whether the resource is tagged with the tag. The resource may be included in the set when the resource is tagged with the first tag and not included in the first set otherwise. Determining whether the resource is tagged with the tag may include searching for a tagged association that identifies the tag and the resource. Alternatively or additionally, determining whether the resource is tagged with the tag may include determining whether a tagging criterion, identified by a matched tag that identifies the tag, is met for the resource. The resource may be tagged with the tag, in response to determining that the tagging criterion is met for the resource.

A condition entity may be a tagged resource and may be included in a set of tagged resources in a resource scope. As such, a first set of resources tagged with a first tag and in a first resource scope defined by a first scope descriptor may include a second condition entity. A second scope descriptor may include a second scope condition that is met based on the second condition entity. Alternatively or additionally, a second set of resources tagged with the first tag and in a second resource scope defined by a second scope descriptor may include a first condition entity. The first scope descriptor may include a first scope condition that is met based on the first condition entity. For example, a first user may be identified by first account information maintained and/or otherwise accessible to an execution environment 401, in any of FIGS. 4A-D. The first user represented by the first account information is a first resource with respect one or more applications 403 and/or components in the execution environment. Users represented in the execution environment 401 may be tagged. A first scope condition, in a first scope descriptor that is created and/or otherwise maintained by a scope director component 404, may be determined to be met or not met based on a relationship of the first user to a second user. The relationship may be stored in a record of database and/or in any other suitable storage. For example, the first scope condition may be met for a user who is an employee who is not a manager and is logged in. The first user may be an employee who is not a manager and may be logged in. A second scope condition may be based on account information based on a second user. The second scope condition may be met when the second user is a manager of a logged in employee. The first user may report to the second user. Both the first user and the second user may be tagged with a site/location identifying tag, which may be identified by one or more matched tags. A first scope criterion in the first scope descriptor may be met for all users who are logged in specified and management chain. When the first user is logged in, the first scope descriptor is active and the first scope criterion is met for the second user. The second user is in a first set of resources tagged with the tag in a first scope defined by the first scope descriptor. In the example, the first user is not in the first set since the first scope criterion is not met for the first user. A second scope criterion in the second scope descriptor may be met for all users that have been employed more than ten years. The first user may be employed 12 year, thus the second scope criterion is met for the second user. When the second user is logged in and the first user is logged in, the second scope descriptor is active and the second scope criterion is met for the first user. The first user is in a second set of resources tagged with the tag in a second scope defined by the second scope descriptor. In the example, whether the second user is also in the second set depends on how long the second user has been employed. Thus, the first condition entity may not be in the first set and/or the second condition entity may not be in the second set. Still further, identifying the first scope descriptor and identifying the second scope descriptor may be based on a third entity. The third entity may be a third resource in one, both, or neither of the first set or the second set.

A condition entity may be and/or may include a resource that is tagged with a tag in a scoped tag for determining a set of tagged resources in a resource scope identified based on the scoped tag. With respect to FIG. 2, the first scope descriptor may include a first scope condition that is met based on a first condition entity that is tagged with the first tag. Alternatively or additionally, the second scope descriptor may include a second scope condition that is met based on a second condition entity that is tagged with the first tag. The first condition entity may include a first file, a first data container, a first record, a first stream, first text data, first image data, first audio data, a first executable resource, a first hardware component, a first user, a first matched tag that identifies the first tag, a first measure of time, and/or a first geospatial location. The second condition entity may include a second file, a second data container, a second record, a second stream, second text data, second image data, second audio data, a second executable resource, a second hardware component, a second user, a second matched tag that identifies the second tag, a second measure of time, and/or a second geospatial location. The first set may include a second resource that is tagged with the second matched tag and/or the second set may include a first resource that is tagged with the first matched tag. For example, see the example in the previous paragraph.

Two different scope descriptors may each be identified based respective scope conditions that are met base on the same condition entities, as described above. With respect to FIG. 2, identifying the first scope descriptor may include determining, based on a first condition entity, that a first scope condition is met, wherein the first scope condition is included in the first scope descriptor. Identifying the second scope descriptor may include determining, based on the first condition entity, that a second scope condition is met, wherein the second scope condition is included in the second scope descriptor. For example, determining the first scope condition is met may be determined based on a first attribute of the first condition entity. Determining that the second scope condition is met may be determined based on a second attribute of the first condition entity.

Determining a set of resources tagged with a tag in a resource scope may include detecting an access to a resource tagged with the tag. Determining the set of resources may be performed in response to detecting the access. With respect to FIG. 2, determining the first set and/or determining the second set may include detecting an access to a resource tagged with the first tag. In response to the access, a determination may be made as to whether the resource is in the first set and/or a determination may be made as to whether the resource is in the second set.

A resource may be accessed in response to an user input detected via an input device. The user input may correspond to a user interface element for accessing the resource. The resource may be accessed for presenting a representation of the resource to a user via an output device.

In another aspect determining a set of resources tagged with a tag in a resource scope may include performing a search based on a scope descriptor. The search may be based on a scope criterion and/or a scope condition in the scope descriptor. With respect to FIG. 2, determining the first set may include performing a search based on the first scope descriptor. Some or all of the first set may be identified based on performing the search. The second set may be determined in an analogous manner.

A specified resource may be in a first scope when first criterion in a first scope descriptor is met. The specified resource may be in a second scope when a second criterion in a second scope descriptor is met. Further, whether the first scope criterion is met for the specified resource may be based on a first resource and whether the second scope criterion is met for the specified resource may be based on a second resource. Whether the first scope criterion is met may be based on first metadata and/or a first attribute for the first resource and whether the second scope criterion is met may be based on second metadata and/or a second attribute for the second resource. The first resource and/or the second resource may include a file, a data container, a record, a stream, text data, image data, audio data, a executable resource, a hardware component, a user, a matched tag that identifies the first tag, a measure of time, and/or a geospatial location—to name a few examples. With respect to the previous paragraph, the first set may include the second resource and the second set may include the first resource. In an aspect, the first set does not include the first resource and the second set does not include the second resource.

With respect to the previous paragraph, one or both of the first resource and the second resource may be tagged with a tag that tags resources in the first set in the first resource scope and tags resources in the second set in the second resource scope. The first resource may be tagged with a first matched tag that identifies the tag and/or the second resource may be tagged with a second matched tag that identifies the tag.

In another aspect, whether the first scope criterion is met for a specified resource may be based on a first resource and whether a second scope criterion is met for the specified resource may be based on the same first resource. The first scope criterion may be in a first scope descriptor and the second scope criterion may be in a second scope descriptor. In a further aspect, whether the first scope criterion is met may be based on a first attribute of the first resource and whether the second scope criterion is met is based on a second attribute of the first resource.

In FIG. 2, the method may additionally include presenting a representation of a first resource in the at least one resource in correspondence with a first representation of the first tag, wherein the first representation is associated with the first scope descriptor. Input information may be received, in response to a user input targeting the first representation, detected by an input device. The first set may be determined in response to receiving the input information. A representation of a resource, in the first set, may be presented via an output device. In FIG. 6E, a first tag UI element 632e1 is presented along with a first resource UI element 628e representing a first tagging of the first resource. An input corresponding to the first tag UI element 632e1 may be associated with a first scope descriptor by a UI element handler component 433, in aspects of any of the arrangements in FIGS. 4A-D. The UI element handler component 433 may interoperate with a scope detector component 404 and a scope match component 406 as described above to determine a first set tagged with the first tag and in the first resource scope.

In an aspect, presenting the representation of the resource may include sending presentation information via a network to access the display device. The message may be sent asynchronously without receiving a corresponding request.

In another aspect, the first representation may be presented along with a second representation of the first tag identified and associated with the second scope descriptor, The first representation and the second representation may be presented differently

The method in FIG. 2 may further include presenting a representation of the first scope descriptor along with the presented first representation.

In various aspects, resources that may be tagged may include one or more of text data, image data, audio data, form data, streaming data, a user, a group, a legal condition entity, an executable program component, a hardware component, a service, and a process.

Although the first scope descriptor and the second scope descriptor may identify different condition entities, the first scope descriptor and the second scope descriptor may also identify a one or more same condition entities and/or attributes of same condition entities. The one or more same condition entities may include a third user, a resource tagged with the first tag, a time, a date, a duration, a geospatial location, and/or a first matched tag that identifies the first tag. The type of, for example, the third user may be the same for the two scope descriptors. For example, the type may be based on the job title of the third user. In another aspect, the type of the two scope descriptors may be based on different types for the third user. For example, the gender of the user may be included in the type of the first scope descriptor and a location of the birthplace of the third user may be included in the type of the second scope descriptor. The types may be based on different attributes of the third user.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable storage medium for use by or in connection with an instruction execution machine, system, apparatus, or device, such as a computer-based or processor-containing machine, system, apparatus, or device. As used here, a “non-transitory computer readable storage medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable storage medium and execute the instructions for carrying out the described methods. A non-transitory computer readable storage medium is non-transitory. A non-exhaustive list of conventional exemplary non-transitory computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

1. A method for locating tagged resources in a resource scope, the method comprising:
detecting a first tag that tags at least one resource;
identifying a first scope descriptor for the first tag;
identifying a second scope descriptor for the first tag;
determining a first set of resources that are in a first resource scope specified by the first scope descriptor and that are tagged with the first tag; and
determining a second set of resources that are in a second resource scope specified by the second scope descriptor and that are tagged with the first tag, wherein a third resource tagged with the first tag is included in one of the first set and the second set,
wherein performing at least one of the preceding actions comprising the method includes execution of an instruction by a processor

2. The method of claim 1 wherein at least one of identifying the first scope descriptor includes determining, based on a first condition entity, that the first scope condition identified by the first scope descriptor is met and identifying the second scope descriptor includes determining, based on a second condition entity, that a second scope condition identified by the second scope descriptor is met.

3. The method of claim 1 wherein determining the first set includes:
determining whether a first scope criterion identified by the first scope descriptor is met for a resource tagged with the first tag; and
including the resource in the first set when the first scope criterion is determined to be met and not including the resource in the first set otherwise.

4. The method of claim 3 wherein determining the second set includes:
determining whether a second scope criterion identified by the second scope descriptor is met for a resource tagged with the first tag; and
including the resource in the second set when the second scope criterion is determined to be met and not including the resource in the second set otherwise.

5. The method of claim 4 wherein at least one of determining that the first scope criterion is met is based on a first attribute of a first scoping entity and determining that the second scope criterion is met is based on a second attribute of at least one of the first scoping entity and a second scoping entity.

6. The method of claim 5 wherein at least one of determining that the first scope criterion is met includes detecting a change to the first attribute and determining that the second scope criterion is met includes detecting a change to the second attribute.

7. The method of claim 5 wherein the at least one of the first set includes the second scoping entity as a second resource and the second set includes the first scoping entity as a first resource.

8. The method of claim 7 wherein at least one of the first set does not include the first resource and the second set does not include the second resource.

9. The method of claim 5 wherein at least one of the first scoping entity is tagged with the first tag and the second scoping entity is tagged with the first tag.

10. The method of claim 1 wherein at least one of the first set includes a second resource that is tagged with a second matched tag and the second set includes a first resource that is tagged with a first matched tag.

11. The method of claim 1 further includes:
determining that a specified resource is in the first resource scope, in response to determining that the first scope descriptor is met for the specified resource; and
determining that the specified resource is in the second resource scope, in response to determining that the second scope descriptor is met for the specified resource.

12. The method of claim 11 wherein whether the first scope descriptor is met for the specified resource is based on a first scoping entity and whether the second scope descriptor is met for the specified resource is based on a second scoping entity.

13. The method of claim 12 wherein a least one of the first scoping entity and the second scoping entity is included in the at least one of the at least one resource, the first set, and the second set.

14. The method of claim 12 wherein the at least one of the first set includes the second scoping entity and the second set includes the first scoping entity.

15. The method of claim 14 wherein at least one of the first set does not include the first scoping entity and the second set does not include the second scoping entity.

16. The method of claim 1 wherein the method further includes:
presenting a representation of a first resource in the at least one resource in correspondence with a first representation of the first tag, wherein the first representation is associated with the first scope descriptor;
receiving input information, in response to a user input targeting the first representation, detected by an input device;
determining the first set in response to receiving the input information; and
presenting a representation of a resource, in the first set, via an output device.

17. The method of claim 16 wherein the first representation is presented along with a second representation of the first tag associated with the second scope descriptor

18. The method of claim 17 wherein the first representation and the second representation are presented differently

19. A system for locating tagged resources in a resource scope, the system comprising:
a tagging component for detecting a first tag that tags at least one resource;
a scope director component for identifying a first scope descriptor for the first tag;
the scope director component for identifying a second scope descriptor for the first tag;
a scope match component for determining a first set of resources that are in a first resource scope specified by the first scope descriptor and that are tagged with the first tag;
the scope match component for determining a second set of resources that are in a second resource scope specified by the second scope descriptor and that are tagged with the first tag, wherein a third resource tagged with the first tag is included in one of the first set and the second set; and
a processor, wherein at least one of the tagging component, the scope director component, and the scope match component includes an instruction that is executed by the processor during operation of the system.

20. A non-transitory computer readable medium embodying a computer program, executable by a machine, for locating tagged resources in a resource scope, the computer program comprising executable instructions for:
detecting a first tag that tags at least one resource;
identifying a first scope descriptor for the first tag;
identifying a second scope descriptor for the first tag;
determining a first set of resources that are in a first resource scope specified by the first scope descriptor and that are tagged with the first tag; and
determining a second set of resources that are in a second resource scope specified by the second scope descriptor and that are tagged with the first tag, wherein a third resource tagged with the first tag is included in one of the first set and the second set.
